(19) United States
(12) Patent Application Publication
(10) Pub. No.: US 2005/0073195 A1
(43) Pub. Date: Apr. 7, 2005

(54) Steering wheel mounted scroll wheel and method

(76) Inventor: Mark E. Popilek, Clarkston, MI (US)

Correspondence Address: CHRISTOPHER DEVRIES;General Motors Corporation, Mail Code 482-C23-B21, P.O. Box 300, Detroit, MI, 48265-3000, US

(21) Appl. No.: 10/679,601

(22) Filed: Oct. 6, 2003

(51) Int. Cl. B60L 3/00

(52) U.S. Cl. 307/10.1

(57) ABSTRACT

Methods and apparatus are provided for an intuitive and non-distracting way for a driver of a motor vehicle to access and adjust vehicle system settings. The apparatus comprises a plurality of rotary scroll wheels and a plurality of switches, each of the plurality of switches coupled to and actuable by one of the scroll wheels, and each of the plurality of rotary scroll wheels mounted on a steering wheel rim of the motor vehicle. Preferably, one of the scroll wheels is mounted in an upper right hand quadrant of the steering wheel rim and one is mounted in an upper left hand quadrant. The apparatus further includes a control unit electrically coupled to each of the plurality of switches and configured to cause a motor vehicle function to react to a signal received from at least one of the plurality of switches.

### TECHNICAL FIELD

The present invention generally relates to motor vehicle control systems, and more particularly relates to steering wheel mounted scroll wheel control systems and to methods for their operation.

### BACKGROUND

Many modern motor vehicles employ steering wheel-mounted controls that are intended to allow the driver of the motor vehicle to operate certain motor vehicle functions without completely removing his or her hands from the steering wheel and without requiring the driver to divert much of his or her attention from the road. These controls, usually buttons located on the steering wheel web, stalk, or hub, may control a variety of different vehicle systems, including the cruise control system, the radio, and the heating/ventilation air conditioning (HVAC) system. Thus, a vehicle equipped with steering wheel controls allows a driver to change a radio station, alter the passenger cabin temperature, adjust the speed of the vehicle, or modify other vehicle system settings, depending on the configuration of the controls.

Steering wheel controls, despite the intent that they make vehicle system operation more accessible and less distracting to drivers, often have the opposite effect. The buttons that comprise most current steering wheel controls often provide a non-intuitive interface with vehicle systems because they require that the driver toggle multiple times to reach a desired setting, thereby distracting the driver's attention from the road. Also, the location of the controls, most commonly on the steering wheel web, hub, and stalk, requires that a driver move his or her hands from the normal driving position in order to use the buttons, making the driver less able to quickly react to conditions on the road (swerving to miss some road debris, for example) if such conditions should occur while the driver is adjusting one of the controls.

Accordingly, it is desirable to provide a steering wheel mounted control system and method that overcome the above mentioned deficiencies of present controls. Furthermore, other desirable features and characteristics of the present invention will become apparent from the subsequent detailed description and the appended claims, taken in conjunction with the accompanying drawings and the foregoing technical field and background.

### BRIEF SUMMARY

An apparatus is provided for an intuitive and non-distracting way for a driver of a motor vehicle to access and adjust vehicle system settings. The apparatus comprises a plurality of rotary scroll wheels and a plurality of switches, each of the plurality of switches coupled to and actuable by one of the rotary scroll wheels, and each of the plurality of rotary scroll wheels mounted on a steering wheel rim of the motor vehicle. Preferably, one of the rotary scroll wheels is mounted in an upper right hand quadrant of the steering wheel rim and one is mounted in an upper left hand quadrant. The apparatus further includes a control unit electrically coupled to each of the plurality of switches and configured to cause a motor vehicle function to react to a signal received from at least one of the plurality of switches.

A method is provided for controlling motor vehicle functions in an intuitive and non-distracting way. The method comprises programming a control unit to cause a menu comprising a plurality of motor vehicle functions to be displayed on a display in response to rotation of one of a plurality of rotary switches by rotation of one of a plurality of rotary scroll wheels. The control unit is also programmed to select one of the plurality of motor vehicle functions in response to activation of one of a plurality of linear switches, to cause a submenu comprising a plurality of options for the selected function to be displayed on the display in response to activation of the one of the linear switches, and to cause one of the plurality of options to be selected in response to further rotation of the rotary switch by the rotation of the rotary scroll wheel. The control unit then causes the selected option to be activated in response to further activation of the linear switch.

### BRIEF DESCRIPTION OF THE DRAWINGS

The present invention will hereinafter be described in conjunction with the following drawing figures, wherein like numerals denote like elements, and wherein

FIG. 1 schematically illustrates two steering wheel mounted scroll wheels in accordance with an embodiment of the invention;

FIG. 2 schematically illustrates, in cross section, a steering wheel mounted scroll wheel in accordance with an embodiment of the invention.

FIG. 3 schematically illustrates a steering wheel mounted scroll wheel in use, in accordance with an embodiment of the invention; and

FIGS. 4 and 5 schematically illustrate processes in flow chart form in accordance with various embodiments of the invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

In accordance with the invention, a steering wheel mounted control system is provided that includes one or more steering wheel mounted scroll wheels. The steering wheel mounted scroll wheels provide an intuitive and non-distracting means through which the driver of a motor vehicle can access and adjust vehicle system settings, such as vehicle speed, passenger cabin temperature, and the like. In accordance with an embodiment of the invention, the scroll wheels are positioned on a steering wheel at locations proximate the locations where a driver normally grips the steering wheel such that a driver can access them conveniently without having to move or remove his or her hands from the steering wheel. In accordance with a further embodiment of the invention the scroll wheels combine the characteristics of a rotary switch and a button or toggle switch. Instead of a driver having to toggle through adjustable vehicle system settings by pushing multiple steering wheel mounted buttons, as is common with current motor vehicle steering wheel mounted controls, the driver can instead rotate a scroll wheel in order to scroll through vehicle system settings, and then activate the button or toggle switch to select a desired setting. Scroll wheels in accordance with the invention are more conveniently located and require less action to use than conventional steering wheel controls, thus distracting the driver less than do prior art controls.

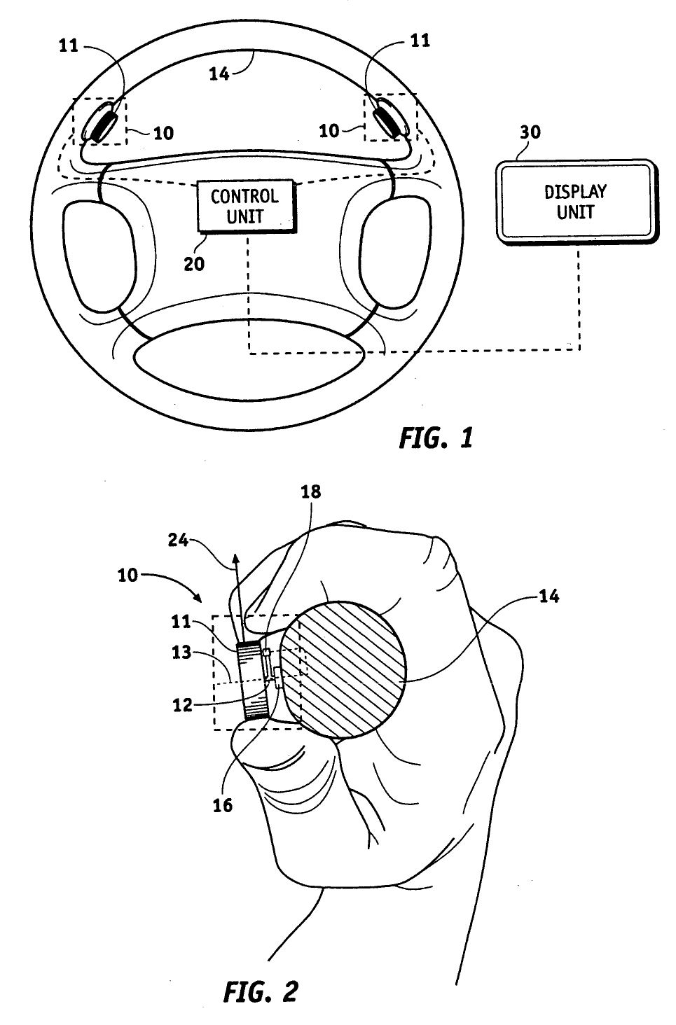

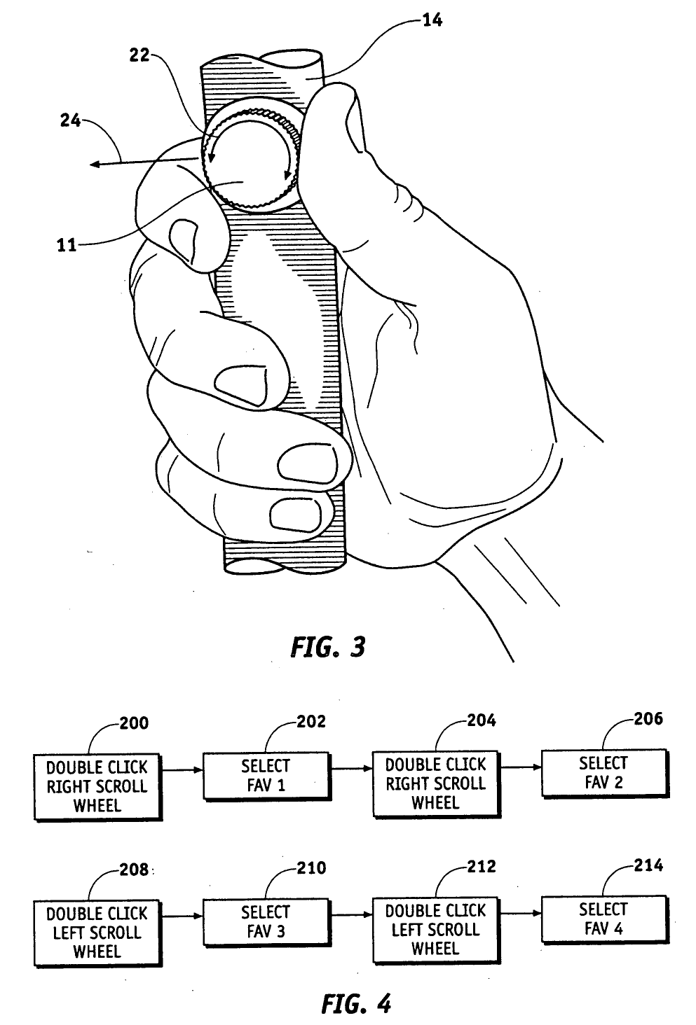

The operation and construction of steering wheel mounted scroll wheels, in accordance with an embodiment of the invention can be understood with reference to FIGS. 1, 2, and 3. Scroll wheels 10 are mounted on steering wheel 14 as schematically illustrated in FIG. 1. In accordance with the illustrated embodiment, two scroll wheels are mounted on steering wheel 14, although a greater or lesser number of scroll wheels can be mounted on the steering wheel as desired. A scroll wheel comprises wheel 11, axle 12, and rotary switch 16. Wheel 11 is preferably circular when viewed head on (as in FIG. 3) and in a preferred embodiment has a crenulated periphery to render it easier to turn as a thumb or finger pushes against the periphery. Scroll wheel 10 is configured so that both wheel 11 and axle 12 revolve about an axis 13 when scroll wheel 10 rotates. In the preferred embodiment of the invention, the scroll wheel is capable of turning an unlimited number of degrees in either the clockwise or counterclockwise direction, although the scroll wheel may be constructed such that the wheel only turns in one direction or is limited in the number of degrees it can rotate. In another preferred embodiment of the invention, a scroll wheel also includes linear switch 18. Linear switch 18 can be a push button or toggle switch that is activated by pushing wheel 11 in the direction indicated by arrow 24. In a preferred embodiment of the invention, rotary switch 16 causes a tactile and/or audible feedback to the driver whenever axle 12 turns a predetermined number of degrees (for example, 20 degrees), and linear switch 18 creates an audible and/or tactile feedback when axle 12 is pushed forward, in a direction substantially perpendicular to axis 13, activating the switch. Rotary switch 16 and linear switch 18 are coupled to control unit 20 through a local access network (LAN) or the like. Control unit 20 may be a standalone microprocessor, part of the motor vehicle engine control unit, or the like. The control unit, in turn, is coupled, again through a LAN or the like, to one or more systems the performance of which are to be selected and controlled, such as the motor vehicle cruise control system, the radio, the heating/cooling air conditioning (HVAC) system, or the like (none illustrated). The control unit may be programmed in a known manner to those of skill in the art to operate or control some features of these vehicle systems. Coupled in this manner, when a driver makes changes to a vehicle system setting using a steering wheel scroll wheel, the control unit communicates the selected setting to the appropriate vehicle system. In accordance with an additional embodiment of the invention, control unit 20 is also coupled to display unit 30 by means of a LAN or the like. Display unit 30 can be a dash board display, heads up display, or the like. Display unit 30 can be configured to display possible vehicle system setting options as well as the currently selected vehicle system settings. Scroll wheels 10 are positioned on the steering wheel with axle 12 parallel to the radius of steering wheel 14. Although the two scroll wheels illustrated in FIG. 1 are located at the 10 and 2 o'clock positions (the upper left and right hand quadrants) on the steering wheel, approximately at the usual positions for a driver's hands, the scroll wheels may be mounted at other positions on the steering wheel. In accordance with a further embodiment of the invention, the position of the scroll wheels can be moveable by the driver so that the driver can position them in the most convenient location. The scroll wheels can be moved, for example, along a slot (not illustrated) in the inner circumference of the steering wheel. Once located at positions convenient for a particular driver, the scroll wheels can be locked into those positions by clamps, screws, or the like. Electrical contacts to the scroll wheels can be routed through the steering wheel.

In accordance with a further embodiment of the invention, when the steering wheel is rotated a predetermined number of degrees off center (for example, 90 degrees), the scroll wheels are deactivated. The control unit is programmed to ignore the signals from the scroll wheel switches. This deactivation of the scroll wheel switches prevents accidental changes to the functions controlled by the scroll wheels while the steering wheel is being turned. These changes might otherwise result from the scroll wheels being accidentally bumped while the driver turns the steering wheel.

A method for controlling motor vehicle systems by using steering wheel scrolling wheels, in accordance with an embodiment of the invention, can be understood from the following and with continued reference to FIGS. 1, 2, and 3. Steering wheel scroll wheels, in accordance with the invention, allow a driver to quickly scroll through vehicle system setting options using the rotary switch functionality. When a driver rotates wheel 11, as indicated by arrow 22, rotary switch 16 makes or breaks a contact whenever axle 12 rotates a predetermined number of degrees (for example, 20 degrees). Switch 16 is configured with a detent for each of the predetermined number of degrees. For ease of description, rotation through the predetermined number of degrees will hereinafter be referred to as one detent. One detent of the rotary switch corresponds to a predetermined, one unit amount of change in whatever vehicle system the scroll wheel is programmed to operate with at that time. This predetermined amount that the vehicle system setting is incremented or decremented depends on the vehicle system the scroll wheel is then configured to operate. For example, in accordance with one embodiment of the invention, a rotation through one detent of the scroll wheel can be programmed to cause a change of one mile per hour (mph) on the vehicle cruise control system, a one degree change on the HVAC system, or the like. Each time the rotary switch rotates through one detent, it causes a message to be communicated to control unit 20 which, in turn, is programmed to cause a vehicle system setting to increment or decrement by one unit, depending on the direction the wheel was rotated. In an additional embodiment of the invention, each time the rotary switch detents and causes the control unit to increment or decrement a vehicle system setting, the control unit is programmed to also cause display unit 30 to display the new vehicle system setting. For example, if the steering wheel mounted scroll wheels are configured to operate with the vehicle cruise control system, and each detent corresponds to a one mph speed change, rotating a scroll wheel five detents clockwise would result in the motor vehicle slowing down by five miles per hour, in one mph increments. Each time the speed is decremented by one mph, display unit 30 displays the new speed to which the cruise control is set.

In accordance with a further embodiment of the invention, a scroll wheel equipped with a linear switch permits a driver to scroll through vehicle system setting options to select a setting using the rotary switch functionality, and then to confirm the selection using the linear switch functionality. The linear switch is used to confirm a particular vehicle system setting the driver selects using the scroll wheel's rotary switch functionality. For example, the driver can scroll through a menu of setting options using the scroll wheel and can select one item from the menu by depressing the linear switch when the selected menu item is displayed. In a preferred embodiment of the invention, display unit 30 displays the option that has been selected using the rotary functionality of the scroll wheel. When the driver reaches the setting he or she wants, the driver pushes wheel 11 forward, in the direction substantially perpendicular to axis 13 (as indicated by arrow 24), causing linear switch 18 to make or break a contact, depending on the type of switch and the type of circuitry employed. For ease of discussion, such making or breaking of a contact will hereinafter be referred to as a “click.” When the linear switch clicks, it sends a signal communicating to the control unit that the driver has confirmed the vehicle system setting currently selected by the control unit. The control unit is programmed to then command the vehicle system to adjust to that particular setting. For example, if the steering wheel mounted scroll wheels are configured to operate the motor vehicle's radio, rotating a scroll wheel three detents would cause the control unit to select the third radio preset, and then pushing the scroll wheel until it clicks would cause the control unit to cause the radio to tune to the that preset radio station.

In accordance with an additional embodiment of the invention, the control unit can be programmed to cause certain vehicle systems to adjust to a new vehicle system setting whenever a scroll wheel is turned, while the control unit also is programmed to cause other vehicle systems to adjust to a new vehicle system setting only when the linear switch is pushed. For example, the cruise control system might be configured such that the vehicle speed is adjusted whenever a scroll wheel is rolled without the linear switch being pushed. The HVAC system, however, might be configured such that it does not adjust the passenger cabin to a new temperature if the scroll wheel is simply turned. Instead, the HVAC system might be configured so that turning the scroll wheel selects a desired temperature, and then pushing the scroll wheel until it clicks causes the control unit to cause the HVAC system to adjust the passenger cabin to this new selected temperature.

In accordance with one embodiment of the invention, the steering wheel scroll wheel, or any or all of the plurality of scroll wheels if the vehicle is provided with more than one, can be configured to control a dedicated function or can be configured to control a number of different functions through a menu option plan. For example, if the vehicle is provided with a right scroll wheel and a left scroll wheel, one of the scroll wheels can be configured to control only a single function such as the cruise control function while the other scroll wheel is configured to control radio, CD player, HVAC system, and the like through a menu system to be illustrated in more detail below. A separate display 30 can be coupled to and indicate the setting controlled by each of the independent scroll wheels.

In accordance with yet another embodiment of the invention, the linear switch can be configured to perform additional functions such as selecting commonly accessed vehicle system settings, switching between vehicle system settings, or the like. For example, pushing a scroll wheel forward twice in quick succession, a motion that will henceforth be referred to as “double-clicking,” may switch between the AM frequency band on the vehicle radio and the FM frequency band, and vice versa. If the control unit receives two signals from the same linear switch within a pre-determined amount of time (for example, half a second), the control unit considers this action a “double-click.” The control unit is programmed to then cause a vehicle system to perform a pre-assigned task or switch to a pre-assigned setting. Double-clicking could also be programmed to be used as a short cut for accessing the vehicle cruise control system, for example, instead of first scrolling through the vehicle system setting menu using the scroll wheels and then selecting the cruise control feature by pushing the scroll wheel until it clicks. In accordance with one embodiment of the invention, illustrated in simplified flow chart form in FIG. 4, the scroll wheel system can be programmed so that double-clicking the right scroll wheel (step 200) at any time causes the system to go to a favorite menu item (FAV 1) (step 202). If the system is already in the FAV 1 state, double-clicking the right scroll wheel (step 204) causes the system to go to a second favorite menu item (FAV 2) (step 206). Similarly, double-clicking the left scroll wheel (step 208) at any time causes the system to go to yet another favorite menu item (FAV 3) (step 210) unless the system is already in the FAV 3 state. If the system is already in the FAV 3 state, double-clicking the left scroll wheel (step 212) causes the system to go to a FAV 4 state (step 214). The favorite states FAV 1-FAV 4 can be preselected by the vehicle driver.

In accordance with another embodiment of the invention, the linear switch can be configured to perform still other additional functions (not illustrated). For example, if the linear switch is pushed and held for a predetermined length of time (for example, 1 second), the control unit can be programmed to cause the menu system to go to some predetermined state such as the “home,” start position, or the like.

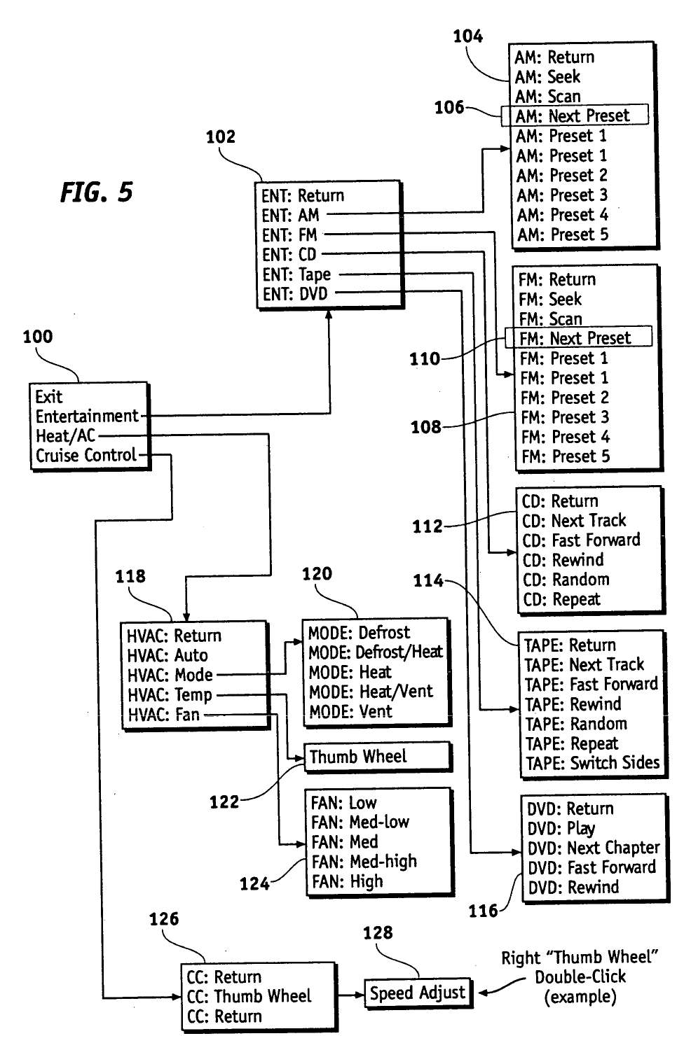

The following are non-limiting examples of the use of scroll wheels in accordance with various embodiments of the invention. In these examples, particular functions are assigned to each of the scroll wheels. In other applications, one or both of the scroll wheels may have other assigned functions. The operation of two steering wheel mounted scroll wheels configured to control a vehicle entertainment system, a vehicle HVAC system, and a vehicle cruise control system is illustrated in FIG. 5 with continued reference to FIGS. 1, 2, and 3. The two scroll wheels in this example are equipped with linear switches and a display is coupled to the scroll wheel control unit, allowing the driver to see vehicle system setting options and also selected vehicle system setting options. Rolling left scroll wheel 10 accesses a vehicle system setting menu (step 100) that gives the driver the option of accessing the vehicle entertainment system, the HVAC system, and the cruise control system. The driver also has the option of exiting the menu. Display unit 30 displays all these options, along with the option the driver has currently selected.

If the driver uses the left scroll wheel to scroll to the entertainment option and then confirms this selection by pushing the scroll wheel until it clicks, the control unit causes the display unit to display the menu for the entertainment system (step 102). In this menu, the driver is given the option of accessing the AM frequency band, FM radio frequency band, CD player, tape player, or DVD player, or returning to the previous menu. If the driver, using the left scroll wheel, scrolls to the AM frequency band option and then confirms this selection by pushing the scroll wheel until it clicks, the control unit causes the display unit to display the menu for the AM frequency band (step 104). This menu gives the driver the option to seek, scan, select a preprogrammed AM band preset, move to the next AM band preset, or return to the previous menu. Scrolling to the “move to the next AM band preset” option and then pushing the left scroll wheel until it clicks causes the control unit to cause the radio to tune to the next AM preset radio station (step 106). All the other AM frequency band options are accessible by first scrolling to a particular option using the left scroll wheel, and then confirming the selected option by pushing the scroll wheel until it clicks.

While in the entertainment menu, if the driver uses the left scroll wheel to scroll to the FM frequency band option and then confirms this selection by pushing the scroll wheel until it clicks, the control unit causes the display unit to display the menu for the FM frequency band (step 108) and the driver has options for the FM band similar to those described above for the AM band. This menu gives the driver the option to seek, scan, select a preprogrammed FM band preset, move to the next FM band preset, or return to the previous menu. Scrolling to the “move to the next FM band preset” option and then pushing the left scroll wheel until it clicks causes the control unit to cause the radio to tune to the next FM preset radio station (step 110). All the other FM frequency band options are accessible by first scrolling to a particular option using the left scroll wheel, and then confirming the selected option by pushing the scroll wheel until it clicks.

In a similar manner, while in the entertainment menu, if the driver uses the left scroll wheel to scroll to the CD player option and then confirms this selection by pushing the scroll wheel until it clicks, the control unit causes the display unit to display the menu for the CD player (step 112) and the driver has options for controlling the CD player similar to those described above for the radio bands. This menu gives the driver the option of playing the next CD track, fast forwarding through the current CD track, rewinding through the current CD track, playing CD tracks at random, repeating the currently playing CD track, or returning to the previous menu. All the CD player options are accessible by first scrolling to a particular option using the left scroll wheel, and then confirming the selected option by pushing the scroll wheel until it clicks. When an option is selected and then confirmed, the control unit causes the CD player to perform the selected action.

In the same manner, while in the entertainment menu, the driver can use the left scroll wheel to scroll to the tape player option and cause the display unit to display the menu for the tape player (step 114) or to scroll to the DVD player option and cause the display unit to display the menu for the DVD player (step 116). Once in these submenus, the driver can further use the scroll wheel to select a desired function or to return to the previous menu.

Alternatively, while in the main menu, if the driver uses the left scroll wheel to scroll to the HVAC system option and then confirms this selection by pushing the scroll wheel until it clicks, the control unit causes the display unit to display the menu for the HVAC system (step 118). This menu gives the driver the option of switching the HVAC system to the auto mode, adjusting the HVAC mode, adjusting the temperature, adjusting the fan, or returning to the previous menu. To illustrate a further embodiment of the invention, all options within the HVAC system menu can be accessed by first scrolling to a particular option using the right scroll wheel, and then confirming the selected option by pushing the right scroll wheel until it clicks. When an option is selected and then confirmed, the control unit causes the display unit to show the appropriate menu for the selected option. This illustrates that selection of options, in accordance with an embodiment of the invention, can be carried out by a configuration in which either or both scroll wheels, in a multi-wheel system, are functional in making the selection.

If the driver uses the right scroll wheel to scroll to the HVAC mode option and confirms this selection by pushing the right scroll wheel until it clicks, the control unit causes the display unit to display the options for the HVAC mode option (120). This submenu gives the driver the option of selecting the defrost mode, the defrost/heat mode, the heat mode, the heat/vent mode, and the vent mode. All options are accessible by first scrolling to a particular option using the right scroll wheel, and then confirming the selected option by pushing the scroll wheel until it clicks. When an option is selected and then confirmed, the control unit causes the HVAC system to adjust to the new HVAC system setting.

In a similar manner, while in the HVAC menu, if the driver uses the right scroll wheel to scroll to the temperature adjust option and then confirms this selection by pushing the scroll wheel until it clicks, the control unit causes the display unit to display the current passenger cabin temperature (step 122). The driver is able to adjust the passenger cabin temperature by rolling the right scroll wheel; each detent changes the selected temperature by one degree Fahrenheit. Each time the scroll wheel's rotary switch detents, the rotary switch sends the control unit a signal telling the control unit to increment or decrement the temperature by one degree. The control unit then causes the HVAC system to adjust the passenger cabin temperature accordingly. The display unit shows the new selected passenger cabin temperature. Pushing the scroll wheel until it clicks causes the control unit to exit the temperature adjust mode and causes the display unit to display the menu for the HVAC system (step 118).

While in the HVAC menu, if the driver uses the right scroll wheel to scroll to the fan adjust option and then confirms this selection by pushing the scroll wheel until it clicks, the control unit causes the display unit to display the fan adjust menu (step 124). This menu gives the driver the option of selecting a low, medium-low, medium, medium-high, or high fan speed. All options are accessible by first scrolling to a particular option using the right scroll wheel, and then confirming the selected option by pushing the scroll wheel until it clicks. When an option is selected and then confirmed, the control unit causes the HVAC system to adjust to the new fan setting.

While in the main menu, if the driver uses the left scroll wheel to scroll to the cruise control system option and then confirms this selection by pushing the scroll wheel until it clicks, the control unit causes the display unit to display the menu for the cruise control system (step 126). This menu gives the driver the option of adjusting the set vehicle speed or returning to the previous menu. If the driver selects the speed adjust option using the right scroll wheel, the driver can then adjust set vehicle speed by rolling the right scroll wheel. Each detent changes the set vehicle speed by one mph. Each time the scroll wheel's rotary switch detents, the rotary switch sends the control unit a signal indicating the driver's intent to increment or decrement the set vehicle speed by one mph. The control unit then causes the cruise control system to adjust the set vehicle speed accordingly. The display unit shows the new set vehicle speed. In accordance with one embodiment of the invention, double-clicking the right scroll wheel from any menu allows the driver to immediately jump to the cruise control speed adjust feature (step 128). In the foregoing illustrative examples, the left scroll wheel has been programmed to control main menu selections as well as features of the entertainment system while the right scroll wheel has been programmed to control features of the HVAC and cruise control systems. These assignments are only illustrative as, for example, one scroll wheel could be programmed to control all menu selection and feature selection functions of the HVAC system. Alternatively, one scroll wheel could be dedicated to a single function, such as the cruise control function, while the other scroll wheel could be used to control all other systems.

While at least one exemplary embodiment has been presented in the foregoing detailed description, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiments. For example, although the invention and its various embodiments have been illustrated by the positioning of two scrolling wheels at particular locations on a steering wheel, it is not intended that the invention be limited in such a way. More or fewer scrolling wheels can be used, and the scrolling wheels can be located at other, possibly moveable, positions on the steering wheel. Further, although in the illustrative embodiments assign particular functions to a right scrolling wheel or to a left scrolling wheel, there is no intent to limit the use of the scrolling wheels to those assigned functions. It should be understood that these and other changes can be made in the function and arrangement of elements without departing from the scope of the invention as set forth in the appended claims and the legal equivalents thereof.

1. A motor vehicle control system comprising:
a rotary scroll wheel coupled to a switch and mounted on a steering wheel rim of a motor vehicle and configured to adjust a function of the motor vehicle;
a control unit electrically coupled to the switch and configured to receive a signal from the switch and to cause adjustment of the function in response to the signal.

2. The motor vehicle control system of claim 1 further comprising a display coupled to the control unit and configured to display an indication of the function.

3. The motor vehicle control system of claim 1 wherein the switch comprises a rotary switch actuable by rotating the scroll wheel about an axis and a linear switch actuable by pressing the scroll wheel in a direction substantially perpendicular to the axis.

4. The motor vehicle control system of claim 3 wherein the axis is parallel to a radius of the steering wheel rim.

5. The motor vehicle control system of claim 1 wherein the rotary scroll wheel comprises a circular portion rotatable about an axis and having a crenulated periphery.

6. The motor vehicle control system of claim 5 wherein the rotary switch is configured to provide feedback if the circular portion is rotated through a predetermined number of degrees.

7. The motor vehicle control system of claim 1 wherein the rotary scroll wheel can be positioned at a location on the steering wheel at the discretion of a motor vehicle operator.

8. A motor vehicle control system comprising:
a plurality of rotary scroll wheels and a plurality of switches, each of the plurality of switches coupled to and actuable by one of the plurality of rotary scroll wheels, and each of the plurality of rotary scroll wheels mounted on a steering wheel rim of the motor vehicle, at least one of the plurality of rotary scroll wheels mounted in an upper right hand quadrant of the steering wheel rim and at least one of the plurality of rotary scroll wheels located in an upper left hand quadrant of the steering wheel rim; and
a control unit electrically coupled to each of the plurality of switches and configured to cause a motor vehicle function to react to a signal received from at least one of the plurality of switches.

9. The motor vehicle control system of claim 8 further comprising a display unit coupled to the control unit and configured to display an indication of the motor vehicle function.

10. The motor vehicle control system of claim 8 further comprising a plurality of display units, each coupled to the control unit and each responsive to a signal from a respective one of the plurality of switches to display an indication of a motor vehicle function.

11. The motor vehicle control system of claim 8 wherein each of the plurality of rotary scroll wheels can be positioned at a location on the steering wheel at the discretion of a motor vehicle operator.

12. The motor vehicle control system of claim 8 wherein each of the plurality of rotary scroll wheels can be configured in association with a specific motor vehicle function and each of the plurality of rotary scroll wheels can be configured cause a specified motor vehicle function to react to a signal from an associated one of the plurality of rotary scroll wheels.

13. The motor vehicle control system of claim 8 wherein at least two of the plurality of rotary scroll wheels can be configured to cause a single motor vehicle function to react to signals received from the at least two of the plurality of rotary scroll wheels.

14. The motor vehicle control system of claim 8 wherein each of the plurality of switches comprises a rotary switch actuable by rotation of a rotary scroll wheel about an axis and a linear switch actuable by movement of the rotary scroll wheel in a direction substantially perpendicular to the axis.

15. The motor vehicle control system of claim 14 wherein the axis is substantially parallel to a radius of the steering wheel rim.

16. The motor vehicle control system of claim 14 wherein the rotary switch is configured to provide feedback upon rotation of the rotary scroll wheel through a predetermined number of degrees of rotation.

17. The motor vehicle control system of claim 14 wherein the linear switch is configured to provide feedback upon activation.

18. The motor vehicle control system of claim 8 wherein the rotary scroll wheel comprises a generally circular cross section having a crenulated periphery.

19. A method for controlling a motor vehicle function in a motor vehicle having a plurality of rotary scroll wheels mounted on a steering wheel of the motor vehicle, each rotary scroll wheel controlling one of a plurality of rotary switches and one of a plurality of linear switches, each of the plurality of rotary switches and each of the linear switches coupled to a control unit and the control unit coupled to a display, the method comprising the steps of:
programming the control unit to cause a menu comprising a plurality of motor vehicle functions to be displayed on the display in response to rotation of one of the plurality of rotary switches by rotation of one of the plurality of rotary scroll wheels;
programming the control unit to select one of the plurality of motor vehicle functions in response to activation of one of the linear switches;
programming the control unit to cause a submenu comprising a plurality of options for the selected one of the plurality of motor vehicle functions to be displayed on the display in response to activation of the one of the plurality of linear switches;
programming the control unit to cause one of the plurality of options to be selected in response to further rotation of the one of the plurality of rotary switches by the rotation of the one of the plurality of rotary scroll wheels; and
programming the control unit to cause the one of the plurality of options to be activated in response to further activation of the one of the plurality of linear switches.

20. The method of claim 19 further comprising the step of programming the control unit to cause a change in the speed of the motor vehicle in response to rotation of a second of the plurality of rotary scroll wheels.

21. The method of claim 19 wherein the step of programming the control unit to cause a menu comprising a plurality of motor vehicle functions to be displayed on the display comprises the step of programming the control unit to cause a menu comprising entertainment system, HVAC system and cruise control to be displayed on the display.

22. The method of claim 19 further comprising the step of programming the control unit to cause a preselected menu item to be selected in response to double clicking one of the plurality of linear switches.

23. The method of claim 19 further comprising the step of programming the control unit to cause a preselected menu item to be displayed in response to pressing and holding for a predetermined length of time one of the plurality of linear switches.

24. The method of claim 19 further comprising the step of programming the control unit to inactivate the plurality of scroll wheels in response to the steering wheel being rotated by a predetermined amount.

25. A motor vehicle control system comprising:
a plurality of rotary scroll wheels and a plurality of switches, each of the plurality of switches comprising a rotary switch and a linear switch coupled to and actuable by one of the plurality of rotary scroll wheels, and each of the plurality of rotary scroll wheels mounted on a steering wheel rim of the motor vehicle;
a control unit electrically coupled to each of the plurality of switches; and
a display unit coupled to the control unit;
wherein the control unit is configured to cause a display of a menu of motor vehicle functions on the display unit in response to activation of one of the plurality of switches.

26. The motor vehicle control system of claim 25 wherein the control unit is further configured to activate one of the plurality of menu of motor vehicle functions in response to rotation of one of the plurality of rotary scroll wheels to select the one of the plurality of menu of motor vehicle functions and confirmation of the selection by pushing the one of the plurality of rotary scroll wheels to click one of the plurality of linear switches.

27. The motor vehicle control system of claim 25 wherein the control unit is further configured to activate a cruise control system in response to rotation of a second one of the plurality of switches.

28. The motor vehicle control system of claim 27 wherein the control unit is configured to change the speed of the motor vehicle in response to rotation of the rotary scroll wheel.
